(19) United States
(12) Patent Application Publication
(10) Pub. No.: US 2016/0005050 A1
(43) Pub. Date: Jan. 7, 2016

(54) METHOD AND SYSTEM FOR AUTHENTICATING USER IDENTITY AND DETECTING FRAUDULENT CONTENT ASSOCIATED WITH ONLINE ACTIVITIES

(71) Applicant: Ari Teman, New York, NY (US)

(72) Inventor: Ari Teman, New York, NY (US)

(21) Appl. No.: 14/752,367

(22) Filed: Jun. 26, 2015

Related U.S. Application Data
(60) Provisional application No. 62/020,712, filed on Jul. 3, 2014.

(51) Int. Cl. G06Q 30/00; G06K 9/62; G06F 17/30; G06K 9/00

(52) U.S. Cl. CPC G06Q 30/018; G06K 9/00288; G06K 9/6215; G06F 17/30247; G06K 9/00906

(57) ABSTRACT

A method and system for authenticating a user's identity, studying user state and reaction, and detecting fraudulent user content associated with online activities. The method and system receives user content which may include video images, and processes the user content using facial recognition algorithms and analyzing various parameters to uniquely identify a user and a potentially fraudulent online posting, activity or profile. The method and system initiates a number of actions based on a determination that the user or posting, activity or profile is potentially fraudulent.

### CROSS-REFERENCES TO RELATED APPLICATIONS

This application claims the benefit of provisional patent application Ser. No. 62/020,712 filed in the United States Patent and Trademark Office on Jul. 3, 2014, the entire disclosure of which is incorporated by reference herein.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE EFS-WEB

Not applicable.

### STATEMENT REGARDING PRIOR DISCLOSURES BY THE INVENTOR OR A JOINT INVENTOR

Not applicable.

### SEQUENCE LISTING

Not applicable.

### BACKGROUND OF THE INVENTION

1. Field of the Invention

This invention relates to online fraud detection, and more particularly, to a method and system for verifying a user's identity, understanding user state, and detecting fraudulent user content associated with online activity.

2. Description of the Related Art

Over the years, a variety of different methods have been developed to detect and prevent fraud. Growing popularity with online activities and services, including online dating services, mobile banking and social networking, has increased the incidence and expense of identity and content fraud online. In addition, enterprise environments, social, dating and sharing websites desire the ability to be more secure and offensive in detecting potential fraud.

It is, therefore, a primary object of the present invention to provide a method and system for authenticating a user's identity and identifying and detecting fraudulent user content associated with online activities.

It is another object of the present method and system to verify the identity of a user with a facial recognition program using the camera in a user's device and ascertain the user's breathing and heart rate to confirm they are a living human.

It is another object of the present method and system to utilize video content to study a user, and identify and understand the user's particular state, which can include the user's physiological and psychological state identified through body movement, facial expression, and posture.

It is another object of the present method and system to utilize video content to determine user state and user reaction to advertisements, which can be studied and improved upon for future and ongoing advertising campaigns.

It is another object of the present method and system to receive and analyze images and content and then compare the images and content to a number of databases for detecting financial theft, sex offenders, stalkers, and false offers online.

It is another object of the present method and system to replace inconvenient and unsafe passwords, radio-frequency identification (RFID) cards, fingerprint devices, and RSA applications, making enterprise environments and social and sharing sites more secure.

It is another object of the present method and system to identify and flag users, profiles and offers as fraudulent based on their creation, connection, or use by IP addresses, devices, and/or networks associated with other fraudulent behavior.

It is another object of the present method and system to utilize machine-learning artificial intelligence (“AI”) techniques with facial recognition processes, so that a user with a new haircut or pair of glasses is still recognized by the system.

It is another object of the present method and system to stop fraud and breach attempts before they succeed by recognizing particular user and content patterns using AI techniques.

It is another object of the present invention to provide a method and system that scans social, dating and sharing profiles online and applies AI and language processing programs to detect and prevent fraudulent users and activity.

It is another object of the present invention to provide a method and system which authenticates a user, using facial recognition and processes which include determining a user's heart rate, breathing pattern, identity and demographic.

It is another object of the present invention to provide a method and system which self-learns, by continually updating algorithms and data based on user input, in order to dynamically assign images and content a Fraud Potential Score.

It is another object of the present invention to provide a method and system which triggers action or alerts based on comparing an assigned Fraud Potential Score to a maximum allowable score predetermined by the administrator or client.

It is another object of the present invention to provide a method and system designed with a neural network, to enable deep learning. In particular, the present method and system is programmable and trainable to recognize patterns and changes, as well as to recognize faces. Further the method and system is capable of training itself to perfect its own algorithms for recognizing faces, people, objects, patterns, and changes, and to rewire and recode itself.

It is another object of the present invention to provide a method and system capable of learning and forming complex patterns unique to a number of users such that the system can identify users that would find each other mutually attractive, based on photo, text, behavioral and timing analysis. As users reject or accept other users the system is capable of self-correcting.

### BRIEF SUMMARY OF THE INVENTION

In accordance with one aspect of the present invention, a method for determining fraudulent content online is provided, the method includes receiving, by a computer system, user content, processing, by a processing device, the user content to determine a likelihood that the user content is presented fraudulently, and initiating one or more actions based on a determination the user content is relatively likely to be presented fraudulently.

The user content may be a referenced image.

The step of processing user content to determine a likelihood that the user content is presented fraudulently includes the steps of searching an image database to identify incidences of a referenced image, and matching incidences of a referenced image with identical or similar images within the image database.

Searching the image database may include searching embedded metadata associated with particular images stored within the image database.

The method further includes identifying one or more fields within the user content, employing the processing device to analyze and assign a first fraud score for each identified field within the user content, initiating one or more actions based on a determination that one or more first fraud scores exceeds a maximum allowable first fraud score, employing the processing device to determine an aggregate fraud score of the user content as a combination of one or more first fraud scores, and initiating one or more actions based on a determination that the aggregate fraud scores exceeds a maximum allowable aggregate fraud score.

The step of initiating one or more actions based on a determination that the aggregate fraud scores exceeds a maximum allowable aggregate fraud score, may further include receiving video content from the user, and employing the processing device to preform a facial recognition process.

In accordance with an additional embodiment, a method for authenticating and verifying user identity is provided. The method includes receiving, by a computer system, image data, processing, by a processing device, the image data to determine a likelihood that the image data depicts a live human, and initiating one or more actions based on a determination that the user image data is relatively unlikely to be a live human.

The step of processing image data to determine a likelihood that the image data depicts a live human may include the steps of employing the processing device to identify and analyze the image data for patterns, changes, and geometry over a pre-determined time frame, employing the processing device to assign a first fraud score for each identified pattern, change, and geometry over the pre-determined time frame, initiating one or more actions based on a determination that one or more first fraud scores exceeds a maximum allowable first fraud score, employing the processing device to determine an aggregate fraud score of the image data as a combination of one or more first fraud scores, and initiating one or more actions based on a determination that the aggregate fraud scores exceeds a maximum allowable aggregate fraud score.

The method may further include the step of employing the processing device to analyze the image data and determine breathing patterns, heart rate, user identity, and user demographic data.

The method may further include the steps of employing the processing device to analyze image data and identify one or more referenced images, employing the processing device to search an image database to identify incidences of the one or more referenced images, and matching incidences of the one or more referenced images with identical or similar images within the image database, and employing the processing device to determine a likelihood that the referenced images presented are associated with a verified user, and initiating one or more actions based on a determination that the referenced images are relatively unlikely to be associated with a verified user.

In accordance with an additional embodiment, a system is provided including a memory, and a processing device, coupled to the memory, which receives image data, processes the user content to determine a likelihood that the user content is presented fraudulently, and initiates one or more actions based on a determination the user content is relatively likely to be presented fraudulently.

The system may include user content having one or more referenced images.

The system may include the processor searching an image database to identify incidences of a referenced image, and matching incidences of the referenced image with identical or similar images within the image database.

The system may include the processor identifying one or more fields within the user content, analyzing and assigning a first fraud score for each identified field within the user content, initiating one or more actions based on a determination that one or more first fraud scores exceeds a maximum allowable first fraud score, determining an aggregate fraud score of the user content as a combination of one or more first fraud scores, and initiating one or more actions based on a determination that the aggregate fraud scores exceeds a maximum allowable aggregate fraud score.

The system may include video content being received from the user and processed using facial recognition.

In accordance with an additional embodiment, a system is provided having a memory, and a processing device coupled to the memory, which receives image data, processes the image data to determine a likelihood that the image data depicts a live human, and initiates one or more actions based on a determination the image data is relatively unlikely to be a live human.

The system may further include the processor identifying and analyzing the image data for patterns, changes, and geometry over a pre-determined time frame, assigning a first fraud score for each identified pattern, change, and geometry over the pre-determined time frame, initiating one or more actions based on a determination that one or more first fraud scores exceeds a maximum allowable first fraud score, determining an aggregate fraud score of the image data as a combination of one or more first fraud scores, and initiating one or more actions based on a determination that the aggregate fraud scores exceeds a maximum allowable aggregate fraud score.

The system may further include the processor analyzing the image data and determining breathing patterns, heart rate, user identity, and user demographic data.

The system may further include the processor analyzing image data and identifying one or more referenced fields, searching an image database to identify incidences of the referenced image, matching incidences of the referenced image with identical or similar images within the image database, determining a likelihood that the referenced images presented are a verified user, and initiates one or more actions based on a determination that the referenced images are relatively unlikely to be a verified user.

In accordance with an additional embodiment, a system for verifying user identity and preventing fraudulent activity in the context of online account transactions is provided. The system includes a computer system having a memory, a processor, and a data storage means, and means for receiving user content for establishment or verification of the account. The system includes an algorithm that operates on the processor that analyzes and assigns a fraud score to the user based on the nature of the user content, and wherein one or more actions are initiated based on a determination that the fraud score exceeds a maximum allowable fraud score.

The algorithm of the system assigns the fraud score by analyzing at least one of the following, content, grammar, anomalies in claims, breaks in language structure, undesirable intentions, and timing of activities.

In accordance with an additional embodiment, a system for verifying user identity, studying user reaction, and preventing fraudulent activity in the context of online account transactions is provided. The system includes a computer system having a memory, a processor, and a data storage means. The system includes a webcam in electronic communication with the computer system for receiving video information for establishment or verification of the account or determining user reaction. The system includes an algorithm that operates on the processor that analyzes and assigns a score to the user based on the nature of the video information, and wherein one or more actions are initiated based on a determination that the score exceeds a maximum allowable fraud score.

The algorithm of the system may assign the score by analyzing at least one of the following, patterns within the video information over a pre-determined amount of time, changes within the video information over a pre-determined amount of time, and geometry of the video information over a pre-determined amount of time.

The algorithm of the system may analyze at least one of the following to determine user state or reaction, body movement, facial expression and posture over a pre-determined amount of time.

In accordance with an additional embodiment, a non-transitory computer readable medium is provided having instructions stored thereon that, when executed by a processor, cause the processor to perform operations. The operations include receiving user content, processing, by the processor, the user content to determine a likelihood that the user content is presented fraudulently, and initiating one or more actions based on a determination the user content is relatively likely to be presented fraudulently.

In accordance with an additional embodiment, a non-transitory computer readable medium is provided having instructions stored thereon that, when executed by a processor, cause the processor to perform operations. The operations include receiving image data, processing, by the processor, the image data to determine a likelihood that the image data depicts a live human, and initiating one or more actions based on a determination the image data is relatively unlikely to be a live human.

### BRIEF DESCRIPTION OF THE SEVERAL VIEWS OF THE DRAWINGS

To these and to such other objects that may hereinafter appear, the present invention relates to method and system for authenticating a user's identity and detecting fraudulent user content associated with online activities, as described in detail in the following specification and recited in the annexed claims, taken together with the accompanying drawings, in which like numerals refer to like parts in which:

FIG. 1 is a high-level flow diagram illustrating a process for authenticating user identity and detecting fraudulent user content associated with online activities in accordance with the preferred embodiment of the present invention;

FIG. 2 is a block diagram illustrating the system for authenticating user identity and detecting fraudulent user content associated with online activities in accordance with an embodiment of the present invention;

FIG. 3 is a block diagram illustrating the system in accordance with an embodiment of the present invention;

FIG. 4-1 is an exemplary flow diagram illustrating an example of the process for authenticating user identity and determining likelihood that the user is fraudulent in accordance with an embodiment of the present invention;

FIG. 4-2 is a continuation of the exemplary flow diagram of FIG. 4-1, illustrating an example of the process for authenticating user identity and determining likelihood that the user is fraudulent in accordance with an embodiment of the present invention;

FIG. 5 is an exemplary flow diagram illustrating an example of the process for scraping content associated with online activities and determining likelihood that the content is fraudulent in accordance with an embodiment of the present invention; and

FIG. 6 is a computer diagram illustrating the system for authenticating user identity and detecting fraudulent user content associated with online activities in accordance with an embodiment of the present invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

The present invention is a method and system for authenticating user identity, studying and determining user state and reactions, and detecting fraudulent user content associated with online activities.

Among the advantages that can be realized through implementing the method and system described herein is the ability to identify fake users and/or fraudulent accounts, offers, profiles, posts, activities and other content. Particularly, content provided through various websites, applications, and social services including, but not limited to, dating and social services (e.g., OkCupid, Match, Tinder, Grindr, LinkedIn, Facebook, Instagram, etc., ‘sharing economy’ services sAirBNB, Uber, Craigslist, etc., publishing services such as: Instagram, Pinterest, Flickr, Imgr, etc., communication/chat services such as: WhatsApp, KIK, Messenger, AIM, etc., and transactional/ecommerce services such as: Amazon, Ebay, etc. Many of the referenced services are plagued with fake accounts, posts, etc.), such as those that attempt to lure a real or authentic user into divulging personal or financial information, using or enrolling in another service (such as luring users on a dating service into pornography services), chat services, or into an online connection allowing stalking or account hacking.

It can be appreciated that the presence of fraudulent accounts, posts, etc., can be particularly costly to the referenced services, as legitimate, paying users often choose to stop using a service after being spammed or “catfished” (referring to a legitimate user being taken advantage of by someone else through the user of a fraudulent account or identity). It's also dangerous, since the ease of someone setting up a fake account makes it possible for him or her to stalk or mislead another user without arousing much suspicion. Upon implementing the technology described herein, many of the referenced problems can be effectively identified, minimized, and/or eliminated.

In certain embodiments, the method and system described herein can be configured with respect to the backend and/or frontend of such services (social networking, dating, ecommerce, etc.). In doing so, accounts, posts, etc., that are determined to be likely to be fraudulent (as well as the sources/origins of such accounts/posts) can be rapidly identified. Having identified such accounts/posts, the accounts/posts can be prevented from being created, flagged for removal, and/or deleted. In certain embodiments, individual standalone applications and/or extensions can be configured to notify a user that an account or post may be fake (for example, this may include a score reflecting the likelihood or probability that the account or post is fraudulent) when they interact with it, such as if a fake account connects with them on Facebook or messages them on OkCupid or another service.

It should be understood that the fake or fraudulent accounts or posts referenced herein may be completely fake (such as those using fake names, stolen or created photos, etc.) or they may be associated with a real person who is misrepresenting themselves in one or more ways (such as lying about age, photos, location, etc.). The fake offers referenced herein can pertain to items such as real estate or product listings which contain fake or stolen photos or information. Such offers are often used to collect the contact information of prospective buyers and lure them into another service or ‘spam’ them. Again, the presence of such fraudulent content can be very costly because it reduces the safety and reliability of the services on which they are posted and directs transactions outside that service.

In certain embodiments, the technologies described herein utilize a multifaceted approach to identify fraudulent accounts, posts, and/or other content. For example, the referenced technologies can be configured to identify the most common methods of fraud, such as for a particular service or profile/offer type. Having identified such common methods, future accounts, posts, etc., can be initially analyzed with respect to the identified most common methods. This reduces the time and computing resources that may be needed to identify a fraudulent account.

For example, if the most common and/or fastest way to identify a fake account on a particular service is determined to be via finding a matching Profile or Offer Photo from another profile (indicating that the later profile likely stole photos), then this approach can be employed initially. However, if the most common and/or fastest way to identify the fake account is determined to be based on the “Timing Profile” of the profile or by “Content Profile” of the profile, such approaches can be prioritized instead. Additionally, in certain implementations the various approaches can be further modified and configured based on requirements, thresholds, etc., dictated by the particular service to which they are being applied. For example, certain types of services (e.g., an ecommerce platform) may be relatively more tolerant of potentially fake accounts/posts than others (e.g., a dating site).

Various aspects of the technologies described herein include one or more methods, such as those described herein. The method is performed by processing logic that may comprise hardware (circuitry, dedicated logic, etc.), software (such as is run on a general purpose computer system or a dedicated machine), or a combination of both. For simplicity of explanation, methods are described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

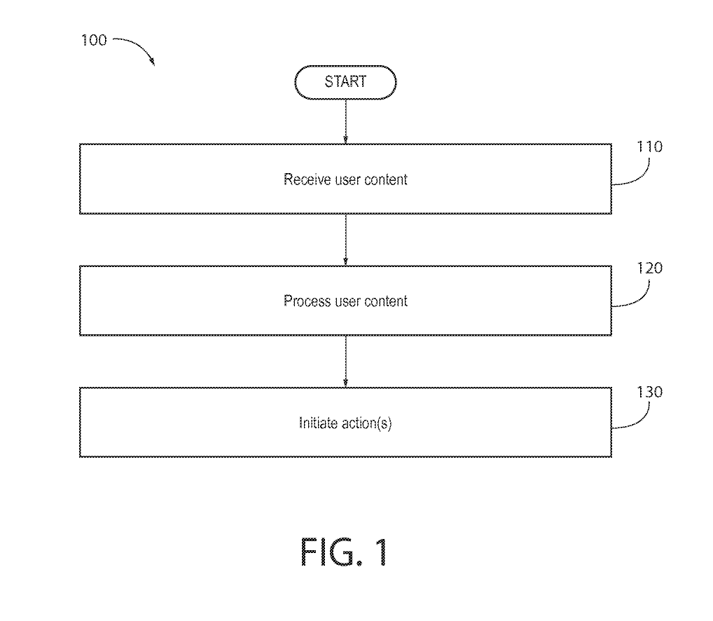

FIG. 1 illustrates an exemplary high-level flow diagram showing a method 100 of identifying fraudulent content use, such as is described herein in various implementations. At block 110, user content can be received (e.g., a picture can be uploaded to a social networking site to create a new profile). At block 120, the user content can be processed. In doing so, a likelihood that the user content is presented fraudulently can be determined. At block 130, one or more actions can be initiated, such as based on a determination the user content is relatively likely to be presented fraudulently.

In the preferred embodiment, at block 120, fake accounts or profiles on social networking sites are identified by matching the referenced photos uploaded to the account against previously uploaded photos which are identical or similar. For example, a fraudulent account user may steal photos from a popular model's Instagram account and post the stolen photos as their profile photos on OkCupid or Tinder.

In order to identify incidences of stolen photos one or more image databases (e.g., stock photography websites, database(s) of popular photos, database(s) of frequently stolen images, etc.) are searched, in order to identify incidences of a particular referenced image (e.g., an image used in a newly created profile). It should be noted that such databases can also be searched with respect to the metadata embedded/associated with the photos, such as EXIF data (e.g., text data embedded in photos that identify items such as the GPS location of the photo, camera type, data and time the photo was taken, IP addresses, filters, etc.).

In certain embodiments, the referenced image searches can be prioritized such that, for example, an ‘internal’ database can be searched first (e.g., against the most-popularly stolen photos), and subsequently outside services can be utilized as necessary, such as those with the highest likelihood of finding a photo with the properties of the referenced photo being compared.

Upon identifying a matching photo, the profile page or offer page associated with the photo can be analyzed (“page” as used herein can refer to any screen, display, interface, or output of data whether visible to a human or machine, including but not limited to apps, JSON response, JavaScript, code, comments, database entries, and any of the myriad ways of storing data entered by a user, service, or generated automatically), as well as any metadata and/or EXIF data available, and such elements can be compared to corresponding entries associated with comparable images found in the referenced database(s). For example, the date/time that the photo was created or uploaded, the date/time that the page was created or updated, the Social Connections Profile of the page, the Content Profiles of the page, and/or the Identity Given of the page (such as the name, age, and demographic information presented on the page, or the identifying product or retailer information) can be determined/identified (both with respect to the referenced image associated with the profile in question, as well as the comparable image(s) identified in the database(s)). Based on such information, a score can be generated, reflecting the probability of which page came first. If the Identity Given is not determined to match (for example the chronologically earlier page claims to be Sarah, age 24, from New York City, but the chronologically later page claims to be Jennifer, age 22, from Tucson), the Fraud Probability Score (FPS) of the Later Page can be increased (because it can be determined that it is likely that “Jennifer from Tucson” is a fake profile that stole the photos from Sarah who put them online earlier).

In scenarios in which ‘false positives’ are identified (e.g., when a higher FPS score is attributed to an authentic profile), such as when reviewing the profile using other techniques/manual review, such false positives can be further analyzed in order to identify the circumstance(s) under question which may have caused the false positive, and such can be factored in, such as for future analyses. For example, where a factor might be used to rate a certain piece of data with a higher FPS only to find that data source to be less reliable, the weight of that SubFPS score can be decreased.

It should be noted that the referenced FPS score may be made up of SubFPS scores. For example, a complex profile may include elements such as images, text, demographic information, network information, interests, contact information, social relationships, etc. Accordingly, each element may have one or more SubFPSs, such as the text's “Grammar SubFPS” being low, indicating the person writing the profile may be a non-native speaker of that language.

Moreover, each SubFPS score may have an associated weight which can be static or dynamic (such as based on other relevant data and context), and the total of the SubFPS scores adjusted for weight is the FPS score. For example, a Profile Page may have an Image SubFPS of 50 (of 100) with Image SubFPS being weighted 9/10, and a text FPS score of 12/100 with a weight of 2/10. In such a scenario, the Text SubFPS will be far less influential (2/10 vs 9/10) than the Image SubFPS. Additionally, in a dynamic weighting system the referenced weights can be configured to be conditional. For example where no Text is included in the Profile, the Interests SubFPS can be ascribed a higher weight than it would otherwise be in a scenario in which additional text is included.

A CFPS is a “Claims FPS” which can reflect a score of the probability of a certain claim being fraudulent, both alone and/or in relation to other claims and information on the page and/or in relation to similar regional, demographic or category claims. For example, an 18-year-old male in New York City claiming to earn $1M+ yearly in 2015 is more likely fraudulent than truthful.

A “Relevance CFPS” can also be computed. For example, if a Profile claims to be African American but the complexion of the face in the profile photo can be determined to be more likely to be Caucasian, the CFPS is increased. Another example is if the Profile claims to be skinny but the Image can be determined to depict a person who is overweight, the CFPS can be increased. Another example is if the Profile claims to be 22 years old but the Image can be determined to depict a person who has gray hair and wrinkles (which are signs of aging well beyond the range of most 22 year olds), the CFPS can be increased. Another example, is an individual claiming to be extremely wealthy in the “Income” field on a site may increase the FPS where the system is told to compare it to the average income claim of some or all of the people on that site, or compare it to people in that location, such as someone claiming to be a multi-millionaire but whose IP address and/or Location Claim put them in the middle of a poor neighborhood.

Various “Standalone CFPS” can be computed. For example, on certain sites and in certain scenarios, a certain claim may, standing alone, be worthy of an increased CFPS. For example, claiming to be 18 on a dating site where the default age is 18 would increase the CPFS for that claim because it's frequently left unchanged by spammers in a rush to create multiple fake accounts. As another example, an individual claiming to be extremely wealthy in the “Income” field on a site may increase the FPS because this is most-frequently a false claim.

In scenarios in which an exact match for a photo is not identified, one or more facial recognition techniques can be used to match the image being examined against a database of individuals (in addition to comparing image data to find exact and edited images). For example, this may occur when someone posts a photo of someone named “James Smith” but claims on their profile to be “Nate Jones”. Since the face of the profile photo can be determined to be that of James Smith, the Image SubFPS and profile FPS can be increased.

In certain embodiments, in a scenario in which it is determined that an image or content is likely to have been stolen from a verified account, or that a profile or offer is impersonating a verified account (thereby resulting in an increased SubFPS or FPS), the verified account holder can be contacted in order to confirm if the account in question is them (in which case it can be verified and/or the FPS can be increased), or if it is an impersonation (or if it is someone who looks similar but is not them). In doing so, fraud and false positives can be minimized in the future.

Moreover, while several of the described techniques pertain to identifying copies of original photos, many fraudulent users may modify photos. Accordingly, various techniques can be employed to identify and reverse engineer photos in order to identify the originals. For example, a fraudulent user might steal a photo(s) and apply a mirroring effect (and/or any number of other image modifications) to it. The presently described techniques can be configured to search for and identify mirror images of photos to see if they exist (e.g., are present in an existing image database).

By way of further example, a fraudulent user may steal a photo(s) and apply filters to it, such as Instagram and Photoshop filters, or apply frames to it. Accordingly, various techniques can be employed to identify filters by analyzing the photo data and reverse engineering the photo to search for potential original photos. In some cases, when a potential original is identified, probable filters and/or frames can be applied in order to determine if doing so increases the similarity of the match between photos.

By way of further example, fraudulent users may add text or logos to images, such as putting URLs or numbers on Tinder profile images (e.g., to encourage users to visit another website or call a number). Using techniques such as OCR (Optical Character Recognition) and other text-identifying technologies, such text (as applied to an image) can be identified. In certain implementations, identifying the presence of such text within an image can increase the Fraud Probability Score (FPS). Moreover, that text can be searched against various databases of known spam text and spam URLs and FPS can be adjusted accordingly.

Fraudulent users may edit images via programs such as Photoshop. By way of further example, the fraudulent users will steal a stock photography image and use the “cloning brush” in Photoshop to hide the watermark on the image. This is difficult to hide perfectly and often times clues left behind in the photo are identified, such as patterns of repetition in the image where areas were duplicated. Accordingly, in certain implementations these potential Photoshop effects can be identified and the FPS can be increased. Coordinates (e.g., XY locations) on the images where these effects appear can also be identified (e.g., so that administrators may review and confirm/deny the report).

It can also be appreciated that some photos may or may not be fake/fraudulent, but nevertheless do not fit the site profile. For example, professionally shot and lit photos are rare on some dating sites and thus can be determined to have a relatively higher probability of being fake. Among the techniques that can be utilized to identify such images including, analyzing the facial geometry, skin quality (e.g., lack of acne, blemishes, marks, wrinkles, etc.), lighting, hair quality (shine, fullness, etc.), photo resolution, background composition, body dimensions, apparel, environment, etc. This data can be processed in order to compute an “Automated Attractiveness Score” (AAS) with respect to the photo. Furthermore, if the AAS is determined to be higher than the average AAS for that service, the present technology will increase the FPS.

Such determinations can also take into account ratings for such images that have been provided by other users (e.g., manually), such as data from services such as Hot or Not, Tinder, Grindr, OkCupid, etc. (where users can vote on the attractiveness of a photo). In doing so, a Manual Attractiveness Score (MAS) can be assigned. For example, a photo rated 5-stars on OkCupid can be determined to be relatively more likely to be fake than one rated 3-stars. Statistically speaking, attractive people are less likely to go online to find a date.

In certain embodiments, the referenced metrics, scores, etc., can be compared against subset averages (e.g., as opposed to universal or site-wide averages), when possible (as different services and regions may have different averages). For example, Tinder in its early days would score higher on AAS and MAS than OkCupid, but once more people began joining and the recruiting was less controlled, the scores decreased. Scores may also be higher for younger daters than older daters (attractive people may get married and leave the system faster while less attractive people may stick around longer). Within a site, different locations, regions, demographics, ages, backgrounds, interests, etc. may have different average scores and such subsets can be compared (such subsets can be both manually and automatically generated). For example, patterns present across multiple images can be identified, as can patterns of demographics, patterns of interests, and patterns of site activity. Users with similar patterns can be grouped together. For example, on a predominantly English site targeted at English-speaking Americans, the appearance of another language would increase the FPS or SubFPS score.

Many spammers will upload photos that don't match the accompanying descriptions. For example, they may upload a photo of a blonde, Caucasian model but identify the profile as Indian. While it's possible for people to look different than their description, the odds are increased that this is a fake account and identifying such discrepancies can increase one or more of the referenced metrics/scores, and/or can flag the profile for review.

Additional examples include, but are not limited to, mismatched photos with age, hair color, weight, height, body type, race, presence of tattoos, percentage of clothed skin and religious identification. For example, recognizing gray hair and wrinkles in a photo of a profile claiming to be 18 years old can be identified as such a discrepancy. It may be that the user forgot to change the correct age and 18 is the default, or it may be a real person attempting to defraud other users, or it may be a fake account. Another example is determining (e.g., based on image analysis) that someone is overweight or their body shape is round while they are claiming to be slim. Such a disparity can be flagged.

Among the techniques encompassed by the present disclosure is the ability to generate an “Automatic Conjecture Profile” (ACP) of a user based on an analysis of photo(s) or video(s) of (an) individual(s) and qualify, quantify, and categorize the real and/or approximate attractiveness, facial structure, facial symmetry, body type, race, gender, age, hair color, eye color, the presence of glasses, the presence of tattoos, the presence of piercings, the percentage of clothing and other coverings on the body, the percentage of hair and/or other items covering the face (often unattractive and dishonest people obscure their face), the type and style of the apparel items, the position of the body and head, items in the background, environment of the background (indoors, beach, office, etc.).

Additionally, the present technology also teaches the ability to compare the referenced “Automatic Conjecture Profiles” (ACP) against data and subsets of data of sites and individual sites to determine if this person is an anomaly worthy of review. For example, if it is determined to be likely that an adult joins a site only for access to children, such a user/profile can be flagged for review.

It should be noted that the referenced analyses of video and photos are not limited to online services, but can be used for real world services. For example, using the same methods, video can be analyzed, such as a security camera of a park, in order to determine if a lone adult is entering a park where only children (and parents with their children) may enter. For example, identifying a male entering a female bathroom. In certain embodiments, a security system can be notified, such as in order to alert a guard to investigate the footage and environment.

In certain implementations, a likelihood or incidence of fraud can be identified based on the location of a photo being uploaded. For example, many web services allow users to upload a photo via URL or by connecting another social account. In one example, Tinder requires users to connect a Facebook account and select photos from there. In such a scenario, the present technologies can be implemented to determine the FPS of the Facebook profile, and prevent accounts with a high, or 100% FPS, score from creating Tinder accounts. IP addresses, network information, and device IDs of the device setting up the account can be logged, in order to increase the FPS of any other accounts (future or past) created by that IP address, device, and network. By attempting to create a Tinder account with a fake Facebook account, the device/network/IP can be identified as being connected to a potential fraudulent user, making all other behavior suspect. Thus, a database can be queried to find if that device/network/IP has been used with other accounts that have been reviewed and the FPS can be increased there.

In another example, a user may enter the URL of a photo recognized by the system to be frequently stolen. As such, the FPS can be increased even without an image search (because such an image is already recognized as one that fraudulent users use). URLs can be checked to determine if they serve dynamic images, such that the URL may remain the same while the image is different. The system may maintain a list of services where this is the case and the URL can be checked each time for the current image content based on current variables and values.

Accordingly, the disclosed technologies encompass the ability to identify and flag profiles and offers as fraudulent based on their creation, connection, or use by IP addresses, devices, and/or networks associated with other fraudulent behavior.

In another example, EXIF data and other metadata associated with a photo can be analyzed. In doing so the name of the creator or owner of the photo, or the location or date when the photo was taken can be identified, and upon determining that it does not match the information entered into the new profile, the FPS can be increased.

While photos are frequently stolen, they usually have a real world source. For example, a model that uploads photos on Instagram is a legitimate use with a legitimate account, even if her photos are then stolen by a thousand fraudulent users. Thus, the various technologies described herein can be configured to “whitelist” an account, whether manually by a client or organization running the system, or automatically (such as based on consistently low FPS scores on content, or a match of a link from a verified account to this page), or by running that user through the video verification process, possibly in conjunction with other verification services such as connecting to an online bank account or having them upload, photograph, or hold to a webcam one or more government IDs (such as license, passport, etc.).

The present system implements the following operations, features, and/or functions (e.g., in combination with one another):
1. identifying stolen profile text
2. identifying patterns of fake profiles (e.g., only include 1 photo, no text, all friends are added within the same timeframe, etc.)
3. recognize structure of pages/applications to determine which images to track
4. date and time stamp photos & friends
   1. determining whether they are all from the time period (e.g., the same day)
   2. determining whether many or all contacts and social connections reflect the same type or category
   3. determining whether the profiles of many or all contacts and social connections were created within the same period
   4. Identifying fake photos, e.g., within Tinder IDs
   5. Identifying fake AirBNB accounts
   6. Identifying OkCupid accounts

It can be appreciated that images (e.g., as displayed on a website or within an application) can be generated dynamically, such as when one or more users attempt to view the photo, and this is often based on the URL. For example a URL might be “http://example.com/photo/1024×768/1234.jpg” which would output image number 1234 at the size of 1024 by 768 pixels. Accordingly, the various techniques described herein can be configured to identify patterns in such URLs which may identify that the image is not the original size. One or more changes can then be applied to such a URL in order to identify the largest and/or most unedited or uncropped version of the photo (e.g., on the server). A database of patterns for the most common services can also be maintained, so that when presented with a URL of an image (e.g. OkCupid) such a URL can be ‘translated’ into the original image.

It should be noted that, in various embodiments, the technologies described herein can be configured to interface with various partner and/or client services, such as in order to grab data (e.g., original images) originally uploaded and stored on various server(s). Additionally, in certain embodiments, the technologies described herein can be configured to interface with other organizations and services to be the first place to which images are uploaded. In such a scenario, such an uploaded image can be verified, and such a verification can be provided to the referenced services, and, for example, transfer the image to their server, or such services can link to and display the image.

Upon identifying a photo or profile as potentially fake, the associated user can be prompted to go to a URL and utilize an application through which they are prompted to face their webcam or other internet-connected camera (e.g., a smartphone or mobile device camera, a webcam, a camera incorporated within a kiosk, etc.) and align their face (and/or hands, body, limbs, etc.) with marks on the screen. Such marks can be moved and rotated and the user can then be prompted to realign their face (and/or hands, body, limbs, etc.) and do so at various angles (e.g., to ensure they are not holding up photos). The image or video can also be analyzed (such as with respect to brightness, flicker rate, etc.) to determine that the user is not holding up or feeding a computer-generated model. The collected data, including but not limited to, geometric analysis of the face, color, hair movement, etc., is then compared to the uploaded photo(s) to determine if the user appearing in the video is likely to be the same individual as in the photos.

This aspect of the present invention is useful for verifying that a person is real and honest, and in doing so the user's profile can be “whitelisted” (or “verified”). For example, an account claiming to be a famous person may be prompted to pose in their webcam in the same position as they are in verified news photograph(s) or video(s) pulled from the web or other databases. A score can then be computed, reflecting the percentage with which the person significantly matches those photos (based upon which account/profile can be “whitelisted,” increase the FPS score, flag for review, etc.). By way of further example, in certain embodiments, a user can be prompted to say certain words, mirror, and/or create certain facial and body expressions. Images or video capture of such gestures are analyzed, such as with respect to the skin, face, and/or body of the user to determine that blood is flowing (indicating that the user is a live human), and to determine heart rate, respiratory rate, wake state (asleep, awake, drowsy, etc.), stress levels, and/or other vital and biological signs. As elevated or abnormal vital signs are common, this may increase or decrease the FPS and/or SFPS. The referenced verification techniques can also prompt the user to respond to questions and analyze micro-expressions (such as the bending of the lower lip indicating lying) to determine an SFPS and/or FPS.

The present system and method analyzes video in real-time to determine a user's heart-rate via beats-per-minute (BPM) and breathing rate, by looking at any or all of the following: (1) change in color of the forehead as blood flows through (such as by isolating a channel of color, such as green, and looking at the change); (2) Movement of the head as blood is pumped through the neck. Specifically, as blood pumps up with force into the head, the head bounces in opposition, in miniscule amounts invisible to the human eye, but visible as pixel changes to a computer analyzing a live camera feed or recorded video segments; (3) pulsation of the skin as blood flows through. Specifically, as blood pumps, vessels in the skin expand and contract, and the system is able to analyze the changes moment-by-moment to see the rate in which blood flows; (4) vibrations of the skin due to other biological factors. For example, the human skin, head and body has a constant vibration due to movements of liquids and electrical forces in the body and a camera and computer are able to see the pixel-by-pixel changes in color and movement; (5) changes in heat given off by the face and body. Specifically, blood and the flow of energy change throughout the body, and exterior forces act on the skin. For example, nearby lamps, screens, devices, sunlight, etc. change the heat signature of a human's face slightly in real-time unlike a still photo or mannequin. The system is able to analyze pixel-by-pixel changes to determine that this individual is human.

Individual humans have signature patterns for forces mentioned in the previous paragraph (including their heart rates, breathing rates, heat of their face and body, movements, eye movements, retinal reactions, and vibrations). The present system and method employs deep learning, using neural networks or other deep learning methods, to recognize anomalies in a person's signatures. That is, for example, if a person has a certain heart rate pattern, and one day attempts to log in and their heart pumps in a different pattern, the system can flag the anomaly and trigger automatic or human reaction, such as locking the person out of the system or calling security personnel to review the situation.

Not only can the system detect biologically driven changes as described above, but it can detect and cause environmental changes. That is, the system can detect and analyze the flicker of a room's lighting on the wall, and then subtract that to get a more accurate BPM (heart-rate) from the change in color of the user's skin (on their forehead or elsewhere). The same approach can be used to adjust for false appearances of vibration or movement caused by environmental lighting.

The present system can cause changes to occur in the environment by causing the screen, camera light, flash, program window (such as a webpage in a browser window, or the screen of an app), or a light or projector embedded in a purpose-driven device, to flash a color or shape or both onto the face of the user or onto the environment, such as a wall, behind the user. For example, the system could cause a red triangle of light to be flashed on the screen and look for that shape to be reflected on the face of the user. Another example, the system could tint the screen unnoticeably to the user, either via high-speed or by subtle changes, and look for those changes reflected on the user's skin and/or user's clothing and/or environment (such as walls) around the user. Thus, pre-recorded video is useless because it would fail to pass any real-time live reactionary tests. It should be obvious that this light may be invisible on the spectrum, such as infrared, or even in the range considered sound such as Doppler, limited only to the capabilities of the users' hardware.

The present system can compare the live video presented to it with 3D information gathered from one or more of the following, distance sensors, radar, multiple camera arrays, lasers, and other methods of detecting distance and/or measuring 3D objects. For example, if the system is presented with a video of a face, and the 3D sensors detect a different shaped face, the system will determine that fraud is present. This may be created by a person holding up a screen, so that the 3D sensor sees a flat shape, even though the video detects a face. In the event the video and the radar show the face in different locations, the system is capable of identifying the possibility that fraud is being attempted.

Micro-changes in the skin, vibration, and head movements need not be detected using a traditional webcam or camera, but can be detected using a radar, infrared detector, or anything capable of analyzing changes in waves. In reality as anyone skilled in the art knows, light and sound exist on the same spectrum.

The system is able to identify the flicker patterns of screens, monitors, light bulbs, natural lighting (sun, moonlight), candles, and paired with deep learning can start to identify the exact light source presented. For example, a fraudulent user might hold up an iPhone6 to the webcam of a laptop, in an attempt to fool the system into thinking a human shown in a video on the iPhone6 is in front of the machine. The system would, however, recognize the flicker rate of the iPhone6 screen and determine it was a screen and not a live human.

Additionally, because the system significantly magnifies the video feed it receives, it determines the pixilation of video (the dots and grid of light, for example) and automatically ascertains that a video image is being presented and not a live human.

The system can operate on multiple cameras with live feeds and compare their images. This offers multiple benefits including: (1) making it more difficult to feed fake video, as the system knows to build 3D geometric models of the faces it sees in each camera and confirm if they match; (2) enabling the user to be in an environment where they must rotate their face. In this case, the user might have multiple cameras arranged in a circle around them so they can turn to look at multiple monitors, windows, or turn to view their office or environment without the system losing visual confirmation of their face. This can be especially useful for users with multiple monitors, such as traders, coders, gamers, and security personnel.

In the event the person's model in one camera does not match the geometry in another, adjusted for the different perspectives, the system can flag it as a potential fraud.

It should be noted that these multiple cameras may be located very close to one another, even right next to one another (with the lenses touching—though they not need be lens-based), as that micro change in perspective will still be detectible.

The system can also include cameras of different focal lengths and focuses, packed together or at a distance, so the user is always track-able no-matter how close or far from the screen they go. This also enables higher-resolution video at close range and at far range, so the system may still do accurate facial recognition.

The system can also analyze the video in real-time to look for changes in pupil expansion and contraction, or retina or iris response. It can look for reactionary changes, such as by flashing or adjusting light and looking for the pupil, retina or iris response. It can also analyze ongoing micro-changes to ensure humanity. With sufficient resolution the system can scan the retina, as each human has a unique retina. The system, that is, can scan each human's eye, both static and moving, to ensure they are alive, unique, and that their identity matches the eye information on record.

In the event the system doesn't have a live video or scan of the user's eye, the system can scan photos of the user which have eye information at high-enough resolution and compare it to live video of the eye, or to other photos uploaded of the user.

The system can also track eye movements including the regular rapid changes of the human eye, and also the movement of the eyes in reaction to objects and changes on a screen or device. That is, for example, the system could flash a light in the corner of a user's screen and if the user's eye doesn't go up to that flash, the system can trigger an alert or action. As another example, if the system determines the user is looking at text data, but the eye doesn't move the way a human eye does when reading, the system can flag an alert or action.

Throughout the day and week, a human's facial hair grows, more pronounced in males, and especially in certain men. The system tracks human facial hair growth and changes (such as shaving) and can trigger actions and alerts based on anomalies. For example, if a user's beard usually grows at a certain rate, but on one day the system sees the user's facial hair remains the same, it can flag an alert that the system may be receiving a pre-recorded video. In various security situations, if the user's facial hair suddenly appears or disappears, the system can alert administrators to a possible security breach or other alert. The system, paired with deep learning, is capable of determining hair styles, and also to identify if the person appears disheveled. This can be used to alert management that an employee or user appears to be losing their composure.

The system with its deep learning can be taught to recognize forbidden objects. For example, the system can recognized a user wearing a camera device that could be used to record the screen, such as Google Glass. The system could lock the screen until the user removes the camera. Obviously, it could also flag and highlight a camera anywhere pointed at the screen that is in view of the webcam(s). This is not limited to recognition of cameras, but any devices, such as a recording device, weapon, beverage, or other banned object.

The system can learn the user's wardrobe and trigger actions or alerts based on changes. For example, if a user usually wears ill-fitting t-shirts and suddenly begins dressing in expensive designer shirts and suits, the system is capable of recognizing the change and alerting security.

The system can also learn when certain facial obfuscation is okay, for example a user having long bangs which cover one eye or both eyes partially. The system can learn that user's unique geometry and not rely on typical facial recognition algorithms.

The system can be programmed to ban or exclude users with certain facial anomalies. For example, when the system is used on a military base it is able to ban users with hair in their face, since it's required on the military base to have short groomed hair.

The system can learn to detect drastic grooming and posture anomalies, in hair, cleanliness, clothing, and posture, to detect a user that is depressed, or otherwise in a non-ideal state.

The system can detect emotional signatures in the face, such as those outlined by Dr. Paul Eckman, including frowns, bent lower lips, wrinkles around the eye in conjunction with smiles, and others. The system can be programmed to recognize certain micro-expressions (those lasting for less than a second, often) as named emotions such as joy, shock, horror, disgust, anger. The system can be programmed to lock screens when a user appears to be acting in anger, for example. Management may choose to have the system track emotions and alert them when a user appears to be frequently angry, or stressed, or otherwise in a state they would want to know about. This could be used by content creators, as well, to gauge reaction to video, interfaces, or information in real-time.

The system is not limited to micro-changes in the face and can recognize fidgeting and other nervous movements of a user. It can recognize when a human appears nervous, excited, angry, stressed, or otherwise, based on the movements of their head, eyes, body, hands, and limbs, and by learning their particular gaits and postures that correspond with their emotional states. The system with its deep learning capabilities can compare these postures and movements to actions, speaking and writings to learn to read a human's body language.

The system can work alongside and together with voice matching, voice signature matching, gait matching, and other recognition systems to confirm humanity, and add additional biological data, vitals, and emotional state data. It can also pull such data to help make decisions.

Currently, identification is given to humans by most agencies and organizations, however, the present system can provide an ever-changing, adapting “Photo ID”, which ages with the user, and changes based on facial hair, grooming, etc. Such that when the user walks up to a security station to be reviewed and is reviewed by human or machine, the human or machine can access the most-recent “Photo ID” stored by the system. This “Photo ID” can actually be multiple photos from different angles, and include 3D data, heat maps, movement signatures, heart-rate and breathing patterns signatures, and more.

The system can detect weight changes when the user is present in front of devices having the present system which matches the ID. The system is programmed to detect the user's weight, and trigger actions based on the data received. For example, healthcare organizations may utilize the system to encourage the user to login for dieting help or to join the gym. A gym can utilize the system to enable instant access to the gym facilities and simultaneously alert the user that they may want to take a complimentary training session.

The system has very large amounts of users, and their respective identifying information, photos, videos and data. Using all of this aggregated information, the system can be programmed to guess the weight, age, height, demographics, gender, etc. of the user. In fact, just based on facial movements as the user speaks, the system is able to recognize and identify where geographically in the world the user is from.

By analyzing changes in throat and lips, the system can read what a user is saying without having to touch them. This could be used to know what is being whispered or said in a location, such as an ATM vestibule, where the user is being watched with video but there are no microphones.

The system can be designed with a neural network, to enable deep learning. That is, the system can be programmed and trained to recognize patterns and changes, as well as to programmed to recognize faces.

The system is capable of training itself to perfect its own algorithms for recognizing faces, people, objects, patterns, and changes, and to rewire and recode itself.

The system can be built modularly so that different roles take place in siloed systems. For example, video processing can be done on an individual machine or network, and this enables another system to watch the bandwidth out of that siloed machine or network, and shut down any connection if it appears video is being transferred. This way, the system can react to any attempt at being hacked and transfer video out of the siloed sections.

The system can identify an over the shoulder Webcam peeper, namely someone other than the user looking at the user's screen. After recognizing the presence of a peeper, in certain environments where only the user is allowed to view the screen and information thereon, the system can lock the screen, log who is viewing the screen, or prompt the user or administrator to approve the peeper.

The system can use machine learning to map common BPM and Body Vibrations to behaviors and trigger events. For example, the system could learn what sexually excites a user by showing photo or video and seeing changes, and could then automatically filter dating matches based on components matching that photos, like a Tinder where you don't even need to swipe.

To add clarity, the machine learning engine could realize that a user is aroused by bushy eyebrows and match the user with users that have bushy eyebrows. The data could then be made available or sold to an advertising service, which can sell the user a video of Andy Rooney or some Eugene Levy movies. The system can learn and form complex patterns unique to each user such that it could identify users that would find each other mutually attractive, based on photo and text and behavioral and timing analysis. As users reject or accept other users the system can self-correct.

The present system's pulse, heat and vibration monitoring is not limited to identity and humanity verification. The data the system receives can be collected and analyzed (in real-time or afterwards) to learn about workplace productivity, health of employees, warn of impending heart failure, breathing issues, depression, stress, anger, weight change, looking disheveled, shaving of a beard.

In the present system, the user does not need to interact with the camera. The camera may be positioned on the ceiling, on a wall, in a vehicle, or near a bed. The system is capable of analyzing the user in any of these alternative environments using the same techniques described herein, to track breathing, heart, head, limb and body movement, temperature via infrared, ambient light, sound if there is a microphone, and movement and interference by third parties. For example, the system may be used in a hospital to track the vitals of a patient and notify medical personnel of changes in vitals. In another example, the system may be used to monitor a bedroom and warn the user of an intruder, or notify emergency personnel of a user having a heart attack.

The system's ability to monitor the heart rate, vibrations, temperature, and movement of those in the bed can be used to measure orgasms, even guiding a user to keep doing a certain act or try something else to help their partner achieve climax. No doubt this would greatly increase satisfaction with online dating. This could be done with a dedicated device by the bed, or by facing the user's cellphone, camera or other webcam (such as a security camera) at the bed. It could be done with any wave sensor, such as radar, camera, IR sensor, or other.

Fraudulent users will often post a photo online that includes multiple individuals. For example, an unattractive individual might post a photo to a service like Tinder or OkCupid, with themselves standing next to an attractive friend. Using facial and body recognition techniques, photos with multiple individuals (such as based on an identification of multiple faces, bodies, more than 2 arms, legs, etc.) can be identified by the system and such photos can be flagged and an FPS score can be increased within the system. For example, a service may choose to prevent the use of such a photo as a main image, or as any image, and/or may penalize or ban the user.

In certain embodiments, the described technologies can be configured to enable other users to “flag” potentially fake accounts. For example, users can submit a URL or ID of the (suspected) fake profile, or by activating a button on an application or extension on a browser. Moreover, users may share communications (e.g., chat sessions, emails, etc.) between them and the account they are reporting, in order to analyze the referenced text to determine a likelihood of fraud (such as by using the described fraud pattern methods, to identify occurrences such as including spam email addresses, luring someone onto another communication platform, asking that person to send them money, etc.).

Because a user may maliciously report legitimate accounts, the described techniques can increase or decrease the trustworthiness of the reporting user based on the results. For example, if a Reporting User is found to be frequently reporting real accounts, such reports can be waitlisted, deprioritized, weighted less, and/or ignored.

Additionally, a real account can be identified as having been hacked by identifying one or more behavior change(s), content types change, language and grammar changes, timing, etc. In doing so, recent activity associated with the account can be compared to previous activity, substantially in the manner described herein with respect to comparing different accounts with one another.

Additionally, in certain embodiments it can be determined whether a real account's owner is experiencing a change in mental state (e.g., being much happier, excited, depressed, angry, scared, in mourning, and/or any myriad of psychological changes) based on identifying behavior changes, content types changes, language and grammar changes, timing, etc. In doing so, recent activity associated with the account can be compared to previous activity, substantially in the manner described herein with respect to comparing different accounts with one another. In certain embodiments, such determinations can be made by comparing words and phrases that appear commonly when a person is in that state to their overall frequency in that person's profile. Additionally, changes in posting frequency and/or changes in the time of day of the posts can also indicate or suggest changes in psychological state.

In addition to images, profiles often contain text. The text may indicate fraudulent behavior is being committed or attempted, or behavior that is undesirable to the service provider (such as sexual content on a family-friendly website). It should be noted that “text” may be embedded in images or Flash or other formats, and the system will recognize that text and analyze it as if it were text or HTML._Examples of such text include:
Links to commercial entities.
Links to known or determined to be spam accounts or fake accounts.
Text attempting to lure to a person into another communication platform (“Contact me at spamaccount@hotmail.com”, “KIK me at: <user_id>”, “Let's chat on this website it: <url>”, etc.)
Text known or determined to be for the purposes of soliciting of transactions, whether or not legal. (Such as mentioning of money, pricing, sales, discounts, etc.)
Text known or determined to be violent or hateful, whether or not legal. (Such as using disparaging terms, phrases used by hate groups, phrases meaning violent acts, references to hate literature, etc.)
Text known or determined to be unhelpful. (Such as reviews with few words, reviews with copied-and-pasted text, reviews on a service like Amazon without the notation “Amazon Verified Purchase” or having a similar meaning telling the user the person who is reviewing the product did not actually purchase on the service, and/or text stored from previous fake accounts and fake postings (such as the text of reviews of AirBNB users that have been deactivated due to fraudulent or undesirable behavior)).
Text that is recognized or determined to have poor grammar, or text having a high probability of being generated by translation software.
Text that is recognized or determined to be copied from other profiles.
Profiles that are missing text. For example, dating profiles that have significantly fewer words than even the most brief real profiles.
Profiles that have been inactive for long periods of time, especially if they were active for only a brief period of time after creation. For example, Facebook accounts that never post new content or like other posts or interact on the site in any way; dating profiles that never communicate, have full mailboxes, have old profiles that haven't been updated in months or years; reviewers on websites that review a single product and never interact again.
Profiles that have been active for very short periods of time and have generated many random connections. For example, many fake accounts on Facebook are generated by “spam farms” which will create thousands of accounts, have them friend each other, and then like/share/recommend/etc. certain content. Additionally, older profiles which have a surge of friends that have recent account ID numbers can be analyzed. For example, determining a Facebook page or profile created years ago that suddenly gets likes or friends who have all been created recently.
Profiles that “like” (or similarly: “follow”, “recommend”, “share,” etc.) content that is determined not to fit the profile's demographic. For example, a 40 year old Christian woman in Mexico liking a page for a New York City young Jewish professionals networking events group. The system can be programmed to recognize this as a likely “purchased” page.

In certain implementations, a text analysis substantially similar to that described herein can be applied with respect to communications between two or more users (private or public such as posting on “walls”). Additionally, the timing and location of the users can be taken into account. For example, a female account messaging a male account about dating, but the accounts are identified on their profiles via IP addresses as being in geographically distant locations.

Examples of timing include: someone messaging at odd hours (increasing the likelihood they are in another time zone), sending messages in batches to multiple users, copying-and-pasting the same message to multiple users, and never replying to messages.

Another example is someone who masks their email address in private messages with patterns such as “name [at] domain [dot] com” or “NameATdomainDOTcom” or similar attempts. This is often indicative that the user is attempting to lure the recipient to a non-approved or non-monitored method of communication and is very common with fraudulent users.

In certain embodiments, the timing and who initiates conversations can also be taken into account. For example, it is rare on dating services that the more-attractive person messages first. It's also rare on dating services that a highly attractive female will message a male first. When this occurs, the probability increases that it is either a spammer or someone who is misrepresenting their desirability.

In certain embodiments, patterns of fraudulent and/or undesirable connections can be recognized. For example:
1. Accounts which are connected to many accounts rapidly. This often implies they are part of a spam farm or have purchased the services of one, or they are a real individual but are attempting to spam many people, such as by inviting them to events or posting on their wall after having a connection request accepted. It is worth mentioning that public relations professionals and advertisers frequently do this and are real accounts but their behavior can be selectively flagged as undesirable by the service provider. In this example, a higher FPS and/or SubFPS is often warranted as they are connecting under a fraudulent basis according to the intentional purposes of the service they are using.
2. Accounts which are connected to known or determined fraudulent users or real accounts with undesirable content. As an example, an apartment sharing service may learn that a user is fraudulent or engaging in unlawful activity (prostitution, sale of drugs, etc.). The service may want to determine all of their users who are connected to the those users determined to be engaging in unlawful activity via social networks such as Facebook, Twitter, and Instagram because there is a higher probability that these connections are also involved in similar behavior. That is, someone who is willingly connected to and receiving the updates from a determined drug dealer may be someone the apartment sharing service finds undesirable based on their community standards. The technologies described herein can enable client organizations to filter users based on the profile of their content. For example, if a user is determined to post or like sexual content publicly, the service may choose to prevent that person from transacting on their system or may flag their profiles for manual review.
3. Individual users can also be notified that a profile they are reviewing is connected to a known potential fraudulent user, potential hyper sexual, potential hyper commercial, potential hyper hateful, etc., or a highly defriended profile or highly reported profile. Being that the described technologies enable users to both manually report profiles, and to install plugins, applications, and extensions, the system can determine when users frequently disconnect from a profile. If someone is being defriended, delinked, or de-liked frequently or rapidly, their FPS score can be increased.

In certain embodiments, when analyzing profiles and photos, elements that are missing can also be identified. For example:
Are photos missing all or parts of the face, as is often the case with users who feel unattractive or are fraudulent or hiding something.
Are profiles missing data that most users of that service enter or find useful (such as age and body type on OkCupid; or such as dimensions of a product in a product listing).

The technologies described herein can be configured to match profile data and photos against databases of criminals and sex offenders. Using facial recognition technology, photos which have a high probability of matching a known criminal can be flagged. For example, a man may sign up for an online dating service and upload a real photo of himself, and such a photo can be analyzed using facial recognition techniques, and compared to others in one or more databases. Where the match is high, the account can be flagged for review by the service provider.

The technologies described herein can also analyze the probability an individual account with one or few postings is fake based on the similarity of the content it produces in grammar (including errors), language, diction, word choice, timing, spelling (including errors), tone, pace, and/or the timing of the posts, such as in relation to other posts. For example, fraudulent accounts may leave positive reviews for a product, service, retailer or provider. This is costly because it misleads others into doing business with someone who would otherwise have primarily negative reviews.

As an example, an unethical physician may hire services to post fake positive reviews to bury or outweigh negative reviews by real clients. The system described herein can be configured to recognize and identify the fake reviews, increase the FPS score on the reviews and accounts and flags them for review. Fake reviews typically come within a very specific and acute time period, have similar language, use a consistent set of words for praise. The system described herein can also be configured to contact the reviewer and ask them to complete a manual verification process, mark the review as unverified until such process is done, and delete (or not post) the review until such verification is done. It should be understood that a comparable process can be applied to screen out fraudulent accounts and postings that are negative or positive.

The system described herein can be configured to create pages and content and request people who identify themselves as being able to provide fake “likes” (and similar, such as “shares”, etc.) through services such as Fiverr and MTurk to provide such services. The technologies described herein can add to the FPS score of every account which does the liking.

For example, a user may request on Fiverr that a provider give them 5000 “likes” to their Facebook page (or retweets, favorites, recommendations, +1 on Google+, etc.). Since these are paid and likely not genuine likes the FPS score of the fake accounts can be increased and they can be entered into a database as accounts known to participate in paid fake social media activity. Facebook may choose to deactivate these accounts for fraud, and the technologies described herein and/or the service provider may choose to initiate a search for other profiles with matching images and behavior patterns. Other pages liked by these users can also be added to the database, as they are also likely clients of such fake services, meaning the profiles liking them are more-likely fake.

When a profile known to use spam “likes” is identified, the FPS score of that profile can be increased. It can be increased further with each like of a page known to use spam likes. As such, a profile can be identified that is likely setup just to provide fake likes, or a real individual who is participating in such fraud.

Additionally, in certain embodiments the system can request that such fraudulent user services setup fake accounts on a website, we would prevent these profiles from actually operating (immediately flagging them as known to be fake because they were created for this purpose, or as “hacked” or “compromised” or “commercial spam account” if they have a history of activity before the system initiates the request), but using the data generated to identify and flag the fake photos and text used to identify other fake accounts setup for others on that and other profiles.

It should be noted that the system described herein can be adjusted or configured to operate within the terms of third party websites (whether clients/partners or non-clients/partners) when examining profiles. The described system can also shift operations to entities and their datacenters in jurisdictions where performing such analysis or data collection is not illegal. The described system can also communicate between multinational entities and have operations performed in a variety of different jurisdictions, and then share whatever data is legally transferable (such as the resulting scores) between jurisdictions to provide a more thorough service. For example, if a website states that it is illegal to use their images, but the company is located in a country wherein it is legal to use online images regardless of the terms, the system described herein can be configured to notify an entity that such a search is recommended and that entity may selectively perform such a search and may selectively return data such as FPS scores. In this regard, the system can operate legally in every jurisdiction.

Among the various operations that can be initiated when an FPS score (e.g., of an image, profile, or offer) is increased include:
1. When a potentially stolen image is identified, that image's data, metadata, and the URL where the image originates, can be stored by the system (e.g., as allowed by the law, terms of the image's host, user, and agreements with the host). These images can then be compared against other images in subsequent searches.
2. The information on the potentially stolen photo can be stored together with any information about modifications, and the profile information, including all text and metadata.
3. A search of the service for the same potentially stolen photo or profile data or offer data can be initiated, since fraudulent users often use the same photo or data to create multiple accounts. For example, a fraudulent user may create 10 fake accounts in different cities with the same photo or profile text. Since the photo or data has been identified by the present system as potentially stolen, the system automatically identifies other locations where the potentially stolen photo has been used and flags those accounts accordingly.
4. Various database(s) of profiles can be updated. This means when another user visits the profile we can notify the visitor that this profile has a high FPS without re-running the search. Such database(s) are also accessible to partner and client service providers so they may choose to review and/or delete or deactivate the fake account or take other actions, such as initiating a site-wide search for copies (as described above). Alternatively, the client may be required to officially request this service and pay the required fees and costs for the processes.
5. Partner or client services can be notified of the FPS score. For example, a dating website may pay for notifications from the present system when a profile with a high FPS is identified. That site then has the ability to take action, manually, automatically, or both, based on the FPS. Additionally, other services such as search engines may choose to remove flagged or potentially fraudulent profiles and offer pages from their indexes or notify users that the pages have a high FPS score.
6. Other users (individuals or organizations) who have interacted with a flagged profile can be notified that it has an increased FPS score. For example, a user may have already initiated a chat with a fake account on a dating service. Such a user can be notified that that account has been determined to have a high probability of being fraudulent.

It should be noted that though much of the forgoing description is directed to embodiments of the system pertaining to identifying fraudulent accounts, profile, postings, etc., the scope of the present disclosure is not so limited. Accordingly, it should be understood that the technologies and systems described herein can be similarly implemented in any number of other settings and/or contexts.

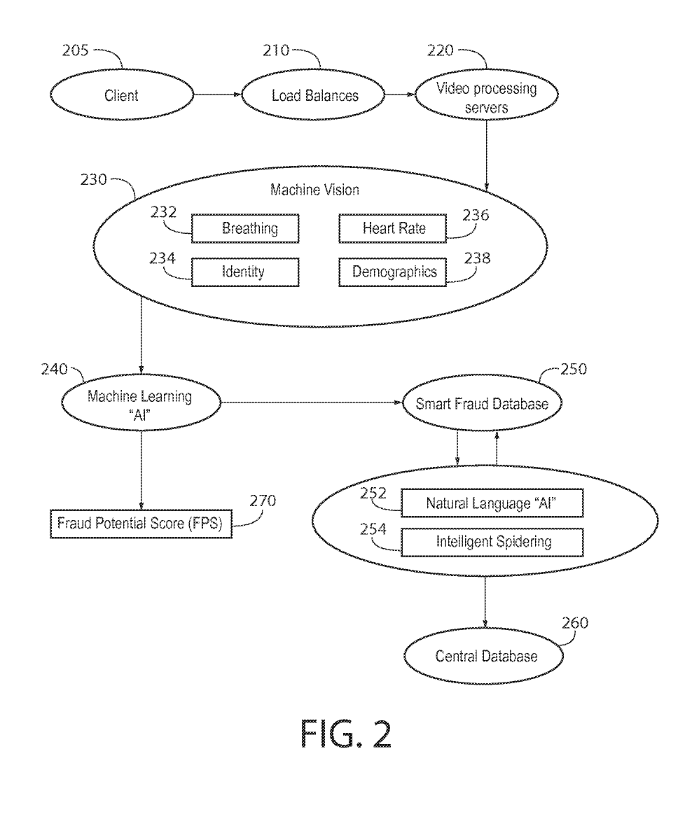

FIG. 2 illustrates the present system 200 for authenticating user identity. The system 200 includes a client 205, load balancers 210, video processing servers 220, machine vision 230, machine learning 240, a smart fraud database 250 and a central database 260. The video processing servers 220 feed the video to the machine vision system 230, which authenticates the identity of the user by analyzing a user's breathing patterns 232, identity 234, heart rate 236 and demographics 238. The machine learning system 240 uses artificial intelligence to analyze data received from the video such that a new haircut or pair of glasses does not trigger false positive. The machine learning system 240 is in communication with the Smart Fraud Database 250 in order to analyze and assign a Fraud Potential Score (FPS) 270. A central image database 260 communicates with the Smart Fraud Database 250 and the system applies natural language algorithms 252 and intelligent spidering algorithms 254 to process language and video content to identify and prevent fraud.

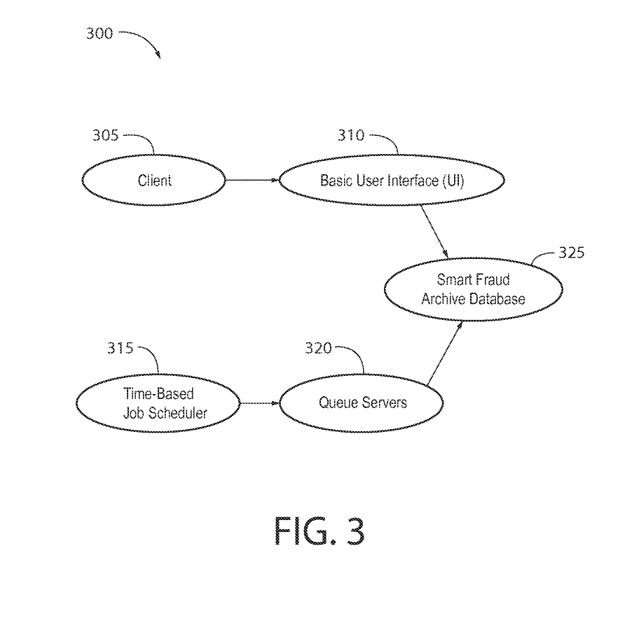

FIG. 3 illustrates the remote and archived architecture associated with the present system 300. The client 305 communicates through a basic user interface (UI), which communicates with the Smart Fraud Database 325. A time based job scheduler 315, preferably Cron Jobs, provides the information into a queue server 320, which then provides the information into the Smart Fraud Database 325.

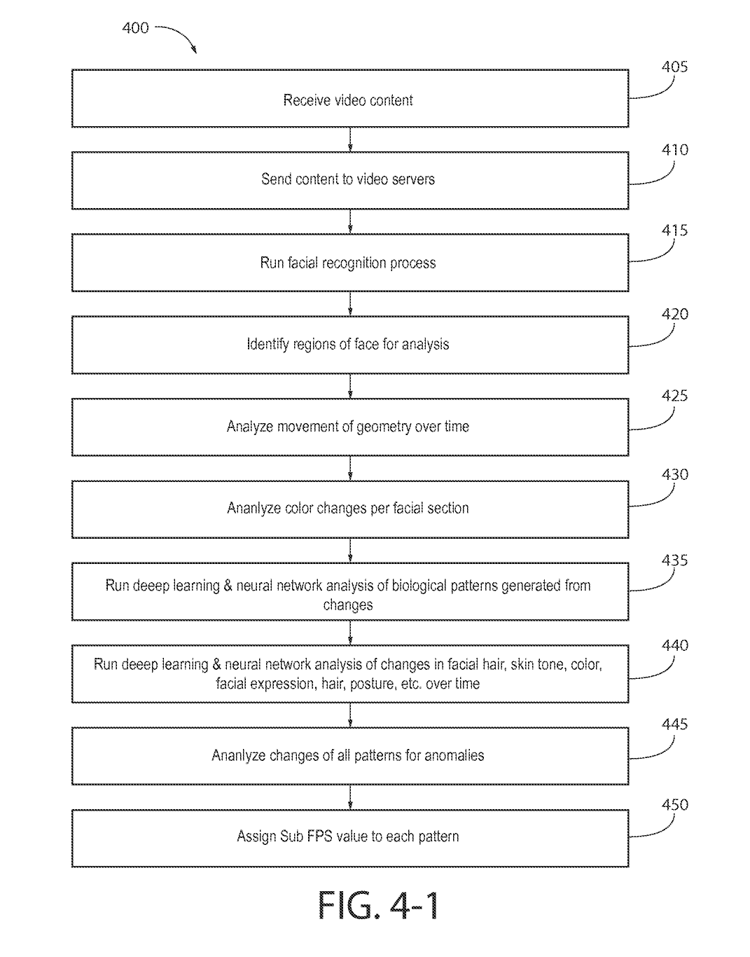

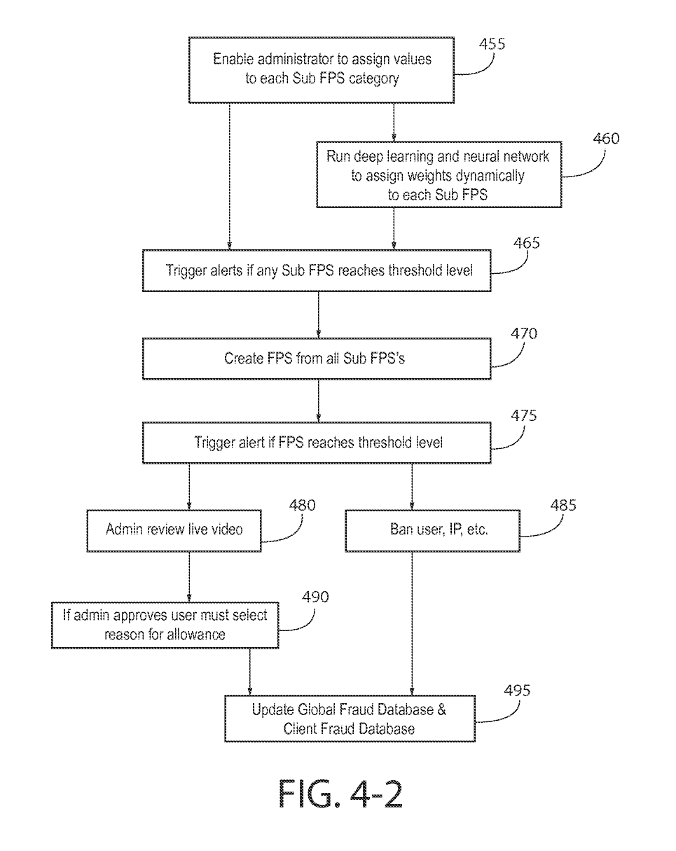

FIGS. 4-1 and 4-2 illustrate a method or process 400 for authenticating user identity and determining if a user is fake using real-time facial recognition and body vital information. At block 205, the system receives video content. At block 410, the system sends the video to the processing server 602. At block 415, the system runs a facial recognition process. At block 420, the system identifies regions of the video content for analysis. These regions may include locations on the face where color changes, edge vibrations, vessels, eyes, retina, iris, pupil, facial hair, mouth, lips, hair, and forehead, etc. At block 425, the system analyzes movement of geometry of the region selected over time. At block 430, the system analyzes color changes per facial section identified, which includes those both changes visible and invisible to the human eye. At block 435, the system runs deep learning and neural network analysis of biological patterns generated from the changes identified. These may include beats-per-minute, vibrations, breathing, eye movements, etc. At block 440, the system runs deep learning and neural network analysis of changes in facial hair, skin tone, color, facial expression, hair, posture, etc. This analysis is completed over a period of time, which may include hours, minutes, days, weeks, etc. At block 445, the system analyzes the changes in patterns searching and identifying anomalies. At block 450, the system assigns SubFPS scores to each pattern. At block 455, an administrator assigns weights, scores or values to each SubFPS category. After which, at block 460, the system runs deep learning and neural network to assign weights dynamically to each SubFPS category by recognizing specific categories that generate a relative amount of fraud. At step 465, the system triggers an alert if a SubFPS reaches a threshold level. The threshold level is pre-determined and set by the administrator or client. At block 470, an FPS is created using all the SubFPSs. The FPS may be calculated using one or more of the dynamically or manually assigned weights accorded to each SubFPS. At block 475, the system triggers an alert if the FPS reaches a threshold level. At block 480, the administrator may manually review the live video, preferably with the permission of the user. At block 285, the administrator may elect to ban the user, IP address, etc. either automatically or after reviewing the live video. At block 490, after the administrator reviews the video, they may elect to approve the user for access to the site or post the content. If they determine that the user is allowed access and/or the content is acceptable, they must select the reason for allowance. The reason may include, for example, approving an object not the person's face by selecting it in a graphical user interface (GUI). At block 495, the system accepts the reason for allowance and updates the Global Fraud Database and Client Fraud Database.

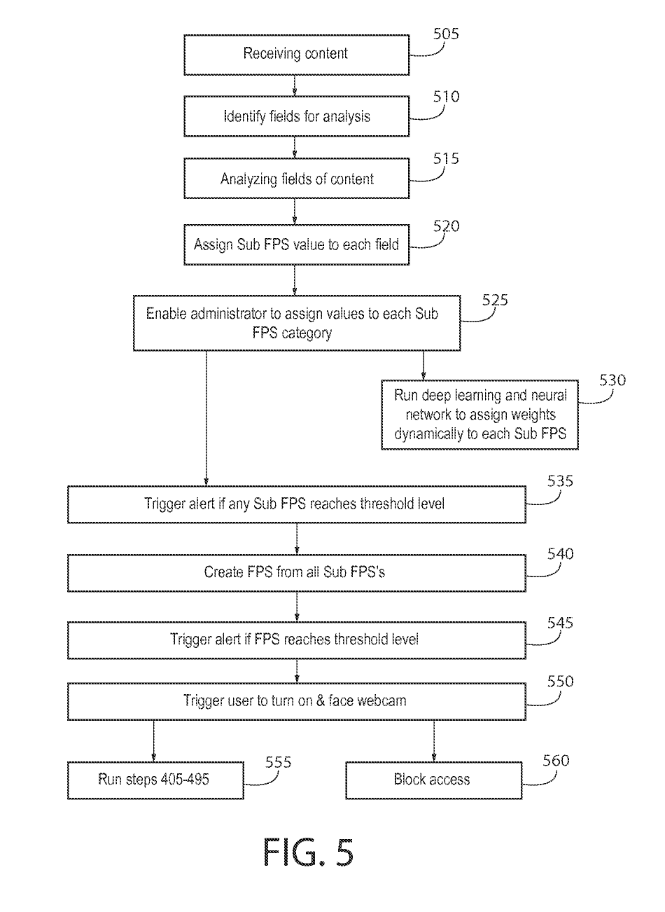

FIG. 5 illustrates a method or process 500 for accessing and scraping content, including profiles and posts, which may be online or local to a system, and determining if the content is real or fake. At block 505, the system, which may use deep learning and neural network, pulls content. The content may include sections of pages as selected by the administrator or client. For example, the client in a GUI can select sections of the page with content and the system can be programmed to recognize the selected fields of the page with content and then recognize that field even if the user interface and code presenting the content change. At block 510, the system identifies fields for analysis. At block 515, the system analyzes the fields of content. At block 520, the system generates or assigns a SubFPS value to each field. The system may also compare the assigned value to an objective range, including an objective range within that user's demographic, or to a range manually set by the administrator. For example, the system can be programmed to recognize that an 18-year-old male is New York City does not likely earn $10 million dollars a year. At block 525, the administrator assigns weights, scores or values to each SubFPS category. After which, at block 530, the system runs deep learning and neural network to assign weights dynamically to each SubFPS category by recognizing specific categories that generate a relative amount of fraud. At step 535, the system triggers an alert if a SubFPS reaches a threshold level. The threshold level is pre-determined and set by the administrator or client. At block 540, an FPS is created using all the SubFPSs. The FPS may be calculated using one or more of the dynamically or manually assigned weights accorded to each SubFPS. At block 545, the system triggers an alert if the FPS reaches a threshold level. At block 550, after an alert is triggered, the user is contacted and asked to turn on their webcam, and face the webcam. At block 560, if the user fails to turn on their webcam, the administrator can ban the user, their IP, block access, etc. to the site. At block 565, after the user turns on their webcam, steps 205-295 are processed for authenticating user identify using facial recognition techniques.

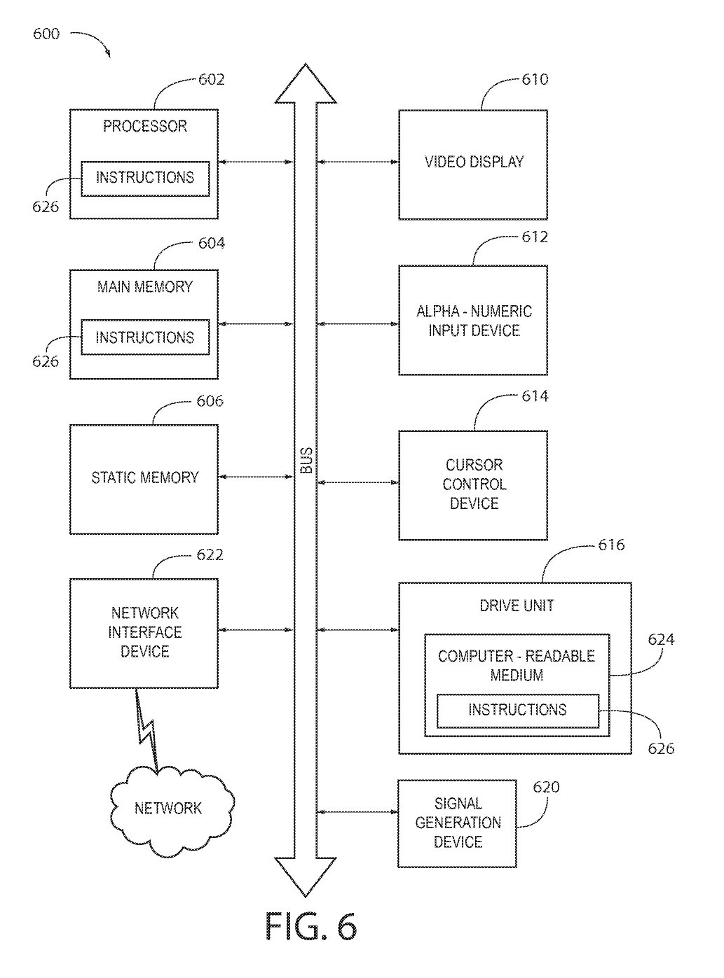

FIG. 6 illustrates an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a mobile or tablet computer, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

The processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by collaboration manager 225, etc.) embodying any one or more of the methodologies or functions described herein. The instructions 626 may also reside, completely or at least partially, within the main memory 604 and/or within the processor 602 during execution thereof by the computer system 600, the main memory 604 and the processor 602 also constituting computer-readable media. The instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be noted, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “receiving,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

I claim:

1. A method for determining fraudulent content online, the method comprising:
receiving, by a computer system, user content;
processing, by a processing device, the user content to determine a likelihood that the user content is presented fraudulently; and
initiating one or more actions based on a determination the user content is relatively likely to be presented fraudulently.

2. The method of claim 1, wherein the user content is a referenced image.

3. The method of claim 2, wherein the step of processing user content to determine a likelihood that the user content is presented fraudulently includes the steps of:
searching an image database to identify incidences of a referenced image; and
matching incidences of a referenced image with identical or similar images within said image database.

4. The method of claim 3 wherein searching the image database includes searching embedded metadata associated with particular images stored within said image database.

5. The method of claim 1, further comprising the steps of:
identifying one or more fields within said user content;
employing the processing device to analyze and assign a first fraud score for each identified field within said user content;
initiating one or more actions based on a determination that one or more first fraud scores exceeds a maximum allowable first fraud score;
employing the processing device to determine an aggregate fraud score of the user content as a combination of one or more first fraud scores; and
initiating one or more actions based on a determination that said aggregate fraud scores exceeds a maximum allowable aggregate fraud score.

6. The method of claim 1, wherein the step of initiating one or more actions based on a determination that said aggregate fraud scores exceeds a maximum allowable aggregate fraud score, includes receiving video content from the user, and employing the processing device to preform a facial recognition process.

7. A method for authenticating and verifying user identity comprising:
receiving, by a computer system, image data;
processing, by a processing device, the image data to determine a likelihood that the image data depicts a live human; and
initiating one or more actions based on a determination that the user image data is relatively unlikely to be a live human.

8. The method of claim 7, wherein the step of processing image data to determine a likelihood that the image data depicts a live human includes the steps of:
employing the processing device to identify and analyze the image data for patterns, changes, and geometry over a pre-determined time frame;
employing the processing device to assign a first fraud score for each identified pattern, change, and geometry over the pre-determined time frame;
initiating one or more actions based on a determination that one or more first fraud scores exceeds a maximum allowable first fraud score;
employing the processing device to determine an aggregate fraud score of the image data as a combination of one or more first fraud scores; and
initiating one or more actions based on a determination that said aggregate fraud scores exceeds a maximum allowable aggregate fraud score.

9. The method of claim 8, further comprising the step of employing the processing device to analyze the image data and determine breathing patterns, heart rate, user identity, and user demographic data.

10. The method of claim 7, further comprising the steps of:
employing the processing device to analyze image data and identify one or more referenced images;
employing the processing device to search an image database to identify incidences of the one or more said referenced images; and
matching incidences of the one or more said referenced images with identical or similar images within said image database; and
employing the processing device to determine a likelihood that the referenced images presented are associated with a verified user; and
initiating one or more actions based on a determination that the referenced images are relatively unlikely to be associated with a verified user.

11. A system comprising:
a memory; and
a processing device, coupled to the memory, to:
receive user content;
process the user content to determine a likelihood that the user content is presented fraudulently; and
initiate one or more actions based on a determination the user content is relatively likely to be presented fraudulently.

12. The system of claim 11, wherein the user content comprises one or more referenced images.

13. The system of claim 12, wherein the processor searches an image database to identify incidences of a referenced image, and matches incidences of the referenced image with identical or similar images within said image database.

14. The system of claim 12, wherein the processor identifies one or more fields within said user content, analyzes and assign a first fraud score for each identified field within said user content, initiates one or more actions based on a determination that one or more first fraud scores exceeds a maximum allowable first fraud score, determines an aggregate fraud score of the user content as a combination of one or more first fraud scores, and initiates one or more actions based on a determination that said aggregate fraud scores exceeds a maximum allowable aggregate fraud score.

15. The system of claim 14, wherein video content is received from the user and processed using facial recognition.

16. A system comprising:
a memory; and
a processing device, coupled to the memory, to:
receive image data;
process the image data to determine a likelihood that the image data depicts a live human; and
initiate one or more actions based on a determination the image data is relatively unlikely to be a live human.

17. The system of claim 16, wherein the processor identifies and analyzes the image data for patterns, changes, and geometry over a pre-determined time frame, assign a first fraud score for each identified pattern, change, and geometry over the pre-determined time frame, initiates one or more actions based on a determination that one or more first fraud scores exceeds a maximum allowable first fraud score, determines an aggregate fraud score of the image data as a combination of one or more first fraud scores, and initiates one or more actions based on a determination that said aggregate fraud scores exceeds a maximum allowable aggregate fraud score.

18. The system of claim 17, wherein the processor analyzes the image data and determines breathing patterns, heart rate, user identity, and user demographic data.

19. The system of claim 16, wherein the processor analyzes image data and identifies one or more referenced fields, searches an image database to identify incidences of the referenced image, matches incidences of the referenced image with identical or similar images within said image database, determines a likelihood that the referenced images presented are a verified user, and initiates one or more actions based on a determination that the referenced images are relatively unlikely to be a verified user.

20. A system for verifying user identity and preventing fraudulent activity in the context of online account transactions comprising:
a computer system having a memory, a processor, and a data storage means;
means for receiving user content for establishment or verification of the account; and
an algorithm that operates on said processor that analyzes and assigns a score to the user based on the nature of the user content,
wherein one or more actions are initiated based on a determination that said score exceeds a maximum allowable fraud score.

21. The system of claim 20, wherein the algorithm assigns the fraud score by analyzing at least one of the following, content, grammar, anomalies in claims, breaks in language structure, undesirable intentions, and timing of activities.

22. A system for verifying user identity, studying user reaction, and preventing fraudulent activity in the context of online account transactions comprising:
a computer system having a memory, a processor, and a data storage means;
a webcam in electronic communication with said computer system for receiving video information for establishment or verification of the account or determining user reaction; and
an algorithm that operates on said processor that analyzes and assigns a score to the user based on the nature of the video information,
wherein one or more actions are initiated based on a determination that said score exceeds a maximum allowable score.

23. The system of claim 22, wherein the algorithm assigns the score by analyzing at least one of the following:
patterns within the video information over a pre-determined amount of time;
changes within the video information over a pre-determined amount of time; and
geometry of the video information over a pre-determined amount of time.

24. The system of claim 22, wherein the algorithm analyzes at least one of the following to determine user state or reaction: body movement, facial expression and posture over a pre-determined amount of time.

25. A non-transitory computer readable medium having instructions stored thereon that, when executed by a processor, cause the processor to perform operations comprising:
receiving user content;
processing, by the processor, the user content to determine a likelihood that the user content is presented fraudulently; and
initiating one or more actions based on a determination the user content is relatively likely to be presented fraudulently.

26. A non-transitory computer readable medium having instructions stored thereon that, when executed by a processor, cause the processor to perform operations comprising:
receiving image data;
processing, by the processor, the image data to determine a likelihood that the image data depicts a live human; and
initiating one or more actions based on a determination the image data is relatively unlikely to be a live human.
